(19) United States
(12) Patent Application Publication
(10) Pub. No.: US 2011/0024648 A1
(43) Pub. Date: Feb. 3, 2011

(54) LUMINESCENT COMPOUNDS

(75) Inventors: Anthony K. Cheetham, Santa Barbara, CA (US); Alexander Birkel, Mainz (DE); Arnaud Huignard, Compiegne (FR); Francois-Julien Vermersch, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/740,919

(22) PCT Filed: Oct. 27, 2008
(86) PCT No.: PCT/FR08/51933

§ 371 Date: Oct. 15, 2010

(30) Foreign Application Priority Data
Oct. 30, 2007 (FR) 0758680

(51) Int. Cl. F21V 9/16; C09K 11/78

(52) U.S. Cl. 250/459.1; 252/301.6 R

(57) ABSTRACT

The subject of the invention is a compound chosen from compounds of formula Y₂BaZnO₅:Er³⁺, La₂BaZnO₅:Er³⁺, Gd₂BaZnO₅:Er³⁺, Gd₂BaZnO₅:Yb³⁺/Er³⁺, Gd₂BaZnO₅:Yb³⁺/Tm³⁺. These compounds are capable of converting radiation into radiation with a higher energy level than that of the incident radiation.

The present invention relates to the field of luminescent materials, in particular materials called “up-conversion” materials, capable of emitting radiation with a higher energy (with a shorter wavelength) than that of the incident radiation.

The most fluorescent compounds have the peculiarity, when they are subjected to radiation of a given wavelength, of re-emitting a second radiation with a greater wavelength and therefore with a lower energy than that of the incident radiation.

Compounds have however been recently discovered that are called “up-conversion” compounds capable of emitting radiation with a higher energy than the incident radiation. This phenomenon, which is explained by successive absorptions of several photons by the same ion or by absorption by different ions followed by energy transfers between said ions, is extremely rare. It is indeed only produced for a few ions, in particular ions of the rare earths or transition metals, when the latter are in a favorable environment. Moreover, the associated luminescence yield is generally very low since the probability of the phenomenon occurring is itself very low. Luminescence yield is defined as the ratio between the quantity of light emitted and the quantity of light necessary to excite the material.

This phenomenon, which makes it possible to obtain very high yields, is called “photon addition by energy transfer” (PAET) or “energy transfer up-conversion” (ETU). This phenomenon employs two ions (identical or different) initially in an excited energy level and non-radiative energy transfer between these two ions.

Most up-conversion compounds are crystalline solids of the oxide or halide type (notably fluoride) doped with lanthanide ions (also called rare earth ions). The compound Y₂O₃ is for example known doped with Er³⁺ which makes it possible to convert radiation in the region of the near infrared radiation into the visible region. Among known compounds, yttrium fluoride YF₃ is also known, doped with Yb³⁺ and Er³⁺ ions (noted YF₃:Yb³⁺/Er³⁺).

The object of the invention is to provide novel up-conversion compounds of which the luminescence yield is high.

To this end, the subject of the invention is a compound chosen from the following compounds: Y₂BaZnO₅:Er³⁺, La₂BaZnO₅:Er³⁺, Gd₂BaZnO₅:Er³⁺, Gd₂BaZnO₅:Yb³⁺/Er³⁺, Gd₂BaZnO₅:Yb³⁺/Tm³⁺.

By convention, the symbol “:” indicates that the ion that follows this is incorporated as a doping ion in the structure of the compound that precedes said symbol. The term dopant should not be interpreted as meaning that the concentration of the ion inserted in the structure is necessarily very low. The symbol “/” indicates co-doping, that is to say doping with several ions. As indicated in the remainder of the text, the dopant concentration may for example exceed 20% in molar percentages. In these structures, the dopant ion partially replaces the Y³⁺, La³⁺or Gd³⁺ ion.

These compounds exhibit an up-conversion phenomenon in the sense that they are able to convert radiation of which the wavelength is situated in the infrared (typically 975 nm) into visible radiation, mainly in the green (approximately 550 nm) and red (approximately 660 nm) regions. Emission in the red is markedly promoted by co-doping with the Yb³⁺ ion. Emission in the blue may also be obtained by co-doping with Yb³⁺/Tm³⁺. The luminescence yield is high and may reach values greater than 1%, in particular for Gd₂BaZnO₅ compounds doped with Yb³⁺/Er³⁺.

The object of the invention is also methods for obtaining compounds according to the invention.

These compounds may be obtained by a solid phase method, namely a method comprising steps consisting of mixing powders, typically powders of oxides or carbonates, of grinding the mixture and optionally pressing it to form a pellet, and then of heating the mixture so as to cause the powders to react together chemically. This method has in particular proved to be advantageous for Ga₂BaZnO₅ matrix compounds.

The compounds according to the invention may also be obtained by a method of the sol-gel type, comprising steps consisting of dissolving precursors (typically nitrates, acetates or carbonates) in water or in a mainly aqueous solvent, of adding a complexing agent (typically an α-hydroxycarboxylic acid such as citric acid) and possibly a cross-linking agent (typically a polyhydroxyalcohol such as ethylene glycol) so as to obtain a gel and then of heating the gel obtained, normally at a temperature of at least 1000° C. Compared with a solid phase method, the sol-gel method generally makes it possible to obtain better homogeneity. Heating to at least 1000° C. makes it possible to overcome disadvantages associated with this method, notably a higher level of impurities (CO₂, water, etc.) which brings about a higher probability of the occurrence of structural defects.

The object of the invention is also the use of compounds according to the invention for converting radiation into radiation with a higher energy than that of the incident radiation, notably for converting radiation with a wavelength of approximately 975 nm into radiation with a wavelength of approximately 550 nm and/or 660 nm. The radiation may or may not be coherent.

The invention will be better understood on reading the following examples.

For all the examples, the up-conversion phenomenon is characterized by the determination, with the aid of a spectrophotometer, of the emission spectrum of the compound when it is subjected to coherent radiation of which the wavelength is 975 nm (obtained by a Ti:sapphire laser pumped by an Ar⁺ laser).

The up-conversion luminescence phenomenon is also characterized by the determination of the luminescence yield.

To this end, radiation coming from a laser diode, with a wavelength around 975 nm, is focused and led through the sample. The intensity emitted by the sample is then measured with the aid of an integrating sphere and reduced to the intensity absorbed by the sample.

### EXAMPLE 1

### Y₂BaZnO₅:Er³⁺

A compound comprising 5 molar % of the Er³⁺ ion in a Y₂BaZnO₅ structure was prepared by a method of the sol-gel type.

The precursors Y(NO₃)₃.6H₂O, Zn(NO₃)₂.6H₂O, BaNO₃ and Er(NO₃)₃.5H₂O were dissolved in deionized water. After heating at 70° C. with stirring to dissolve the metallic salts, citric acid was added so that the molar ratio of metal:citric acid was 1:1, and a solution of NH₄OH was then added to the solution obtained so as to obtain a pH of between 7 and 9. Various heating steps then enabled water to be evaporated off (120° C. and then 140° C.) followed by polymeric residues (150° C., then 170° C., 250° C. and finally 600° C. for 12 h). The powder obtained was ground and then heated at 1000° C. in an alumina crucible for 24 h.

X-ray diffraction analysis revealed that the structure obtained belonged to the Pbnm orthorhombic space group. The parameters of the lattice were a=0.70698 nm, b=1.23368 nm and c=0.57090 nm.

Subjected to incident coherent radiation with a wavelength of 975 nm, the sample exhibited quite strong green luminescence visible to the naked eye. The principal emission was centered on the 550 nm wavelength, lower intensity emissions being centered on 525 and 660 nm wavelengths. The emission at 550 nm was probably due to a transition between the ⁴S_{3/2} and ⁴I_{15/2} levels of the Er³⁺ ion. Emission in the red, which was much weaker, was probably due to a transition between the ⁴F_{9/2} and ⁴I_{15/2} levels.

### EXAMPLE 2

### La₂BaZnO₅:Er³⁺

The compounds 2A and 2B, comprising 5 and 10 molar % respectively of the Er³⁺ ion in an La₂BaZnO₅ matrix, were prepared by the sol-gel route.

The precursors La(NO₃)₃, Ba(NO₃)₃, Zn(NO₃)₂ and Er(NO₃)₃.5H₂O were dissolved in water. After heating at 70° C. with stirring, citric acid and ethylene glycol were added so that the molar ratios of metal:citric acid:ethylene glycol were 1:1:2. After evaporating off water at 125° C., the foam obtained was heated for several hours at 400° C. so as to decompose organic matter. The powder obtained was ground and heated at approximately 1100° C.

The structure obtained belonged to the I4/mcm tetragonal space group. The parameters of the lattice of sample 2A were a=0.68987 nm and c=1.15884 nm, while those of sample 2B were a=0.68835 nm and c=1.15760 nm.

The samples exhibited a strong emission in the green when they were excited by coherent radiation of wavelength 975 nm. Emission at 550 nm was in particular very intense, while a very weak emission in the red (660 nm) increased with the concentration of Er³⁺ ions.

The luminescence yield was 0.06% for sample 2A and 0.10% for sample 2B. The yield of the known compound Y₂O₃:Er³⁺ was of the order of 0.08%.

### EXAMPLE 3

### Gd₂BaZnO₅:Er³⁺ by the solid route

The compounds 3A, 3B and 3C comprising 3, 5 and 10 molar % respectively of Er³⁺ ions in a Gd₂BaZnO₅ structure were prepared by the solid phase method.

The starting products (Gd₂O₃, ZnO, BaCO₃, Er₂O₃) were mixed and then finely ground together in an agate mortar. The mixture obtained was then heated in air in an alumina crucible for 5 hours at 1200° C. After grinding once again, the same heat treatment was again applied.

The structure belonged to the Pbnm orthorhombic space group. The lattice parameters for sample 3A were a=0.71568 nm, b=1.24913 nm and c=0.57724 nm. For sample 3B, a=0.71561 nm, b=1.24903 nm and c=0.57721 nm. For sample 3C, a=0.71540 nm, b=1.24871 nm and c=0.57705 nm. A slight contraction of the lattice was therefore observed when the Er³⁺ ion replaced the Gd³⁺ ion.

A green emission was observed when the samples were exposed to coherent radiation with a wavelength of 975 nm. The emission intensities at 550 nm and 525 nm varied very little as a function of the concentration of Er³⁺ dopants. On the other hand, emission at 660 nm increased strongly with this concentration.

### EXAMPLE 4

### Gd₂BaZnO₅:Yb³⁺/Er³⁺ by the Solid Route

The compounds 4A, 4B and 4C, comprising 1 molar % of Er³⁺ ions and 5, 10 and 20 molar % respectively of the Yb³⁺ ion, were obtained by the solid phase method, in an identical manner to example 3, the precursor of the Yb³⁺ ion being Yb₂O₃.

The structure belonged to the Pbnm orthorhombic space group. The parameters of the lattice for sample 4A were a=0.71501 nm, b=1.24831 nm and c=0.5695 nm. For sample 4B a=0.71420 nm, b=1.24696 nm and c=0.57636 nm. For sample 4C a=0.71248 nm, b=1.24411 nm and c=0.57509 nm.

Under coherent radiation at 975 nm wavelength, the Yb³⁺ ion was excited from its initial ²F_{7/2} state to the ²F_{5/2} level and then transferred its energy to the Er³⁺ ion. The consequence of an increase in the concentration of Yb³⁺ ion was a very significant increase in the emission at 660 nm, which far exceeded the emission at 525-550 nm, and the appearance of a very weak emission in the blue, around 410 nm, due to a phenomenon involving 3 photons and generating a transition from level ²H_{9/2} to level ⁴I_{15/2}. While sample 4A exhibited a green fluorescence to the naked eye, sample 4B emitted overall in the orange and sample 4C in the red. The presence of the Yb³⁺ ion therefore had the effect of very markedly promoting emission in the red to the detriment of emission in the green, probably due to energy transfers that enabled the ⁴F_{9/2} level to be filled. The ratio of the emission intensity in the red to the emission intensity in the green varied in point of fact from more than 2 to almost 14 between sample 4A and sample 4C. Since the sensitivity of the human eye is much greater in the green, light emitted by sample 4A however appeared to the naked eye overall towards green.

The luminescence yield was particularly high, since it was approximately 0.6-0.7% for samples 4A and 4C and 1.35% for sample 4B.

### EXAMPLE 5

### Gd₂BaZnO₅:Er³⁺ by the Sol-Gel Route

The compounds 5A, 5B and 5C comprising 1, 5 and 10 molar % respectively of Er³⁺ ions in a Gd₂BaZnO₅ structure were prepared by the sol-gel route.

The method employed was similar to that described for example 2, the precursor of Gd being Gd(NO₃)₃.6H₂O.

The structure belonged to the Pbnm orthorhombic space group. The parameters of the lattice for sample 5A were a=0.71555 nm, b=1.24919 nm and c=0.57732 nm. For sample 5B a=0.71520 nm, b=1.24855 nm and c=0.57702 nm. For sample 5C a=0.71457 nm, b=1.24772 nm and c=0.57661 nm.

The up-conversion luminescence of these samples was even greater to the naked eye than that obtained in the case of samples obtained by the solid route (example 3).

The luminescence yield was of the order of 0.02% to 0.03% for the three samples.

### EXAMPLE 6

### Gd₂BaZnO₅:Yb³⁺/Er³⁺ by the Sol-Gel Route

The compounds 6A, 6B and 6C, comprising 1 molar % of Er³⁺ ions and 5, 10 and 20 molar % respectively of the Er³⁺ ion in a Gd₂BaZnO₅ matrix were prepared by the sol-gel method.

The method employed was similar to that described for example 2, the Gd precursor being Gd(NO₃)₃.6H₂O.

The structure belonged to the Pbnm orthorhombic space group. The parameters of the lattice for sample 6A were a=0.71504 nm, b=1.24813 nm and c=0.57684 nm. For sample 6B a=0.71406 nm, b=1.24667 nm and c=0.57619 nm. For sample 6C a=0.71287 nm, b=1.24485 nm and c=0.57539 nm.

The luminescence yield varied from approximately 0.2% to approximately 0.5% according to the sample, sample 6B exhibiting the highest efficiency.

As for example 4, the presence of Yb³⁺ ions had the effect of very markedly promoting the emission intensity in the red (660 nm) to the detriment of that in the green (525-550 nm). The ratio of the emission intensity in the red to the emission intensity in the green varied from 2 to 9 between sample 4A and sample 4C.

1. A compound chosen from compounds of formula La₂BaZnO₅:Er³⁺, Gd₂BaZnO₅:Er³⁺, Gd₂BaZnO₅:Yb³⁺/Er³⁺, and Gd₂BaZnO₅:Yb³⁺/Tm³⁺.

2. The compound as claimed in claim 1, of formula Gd₂BaZnO₅ doped with Yb³⁺/Er³⁺.

3. A method for obtaining compounds as claimed in claim 1, comprising mixing the powders, grinding the mixture, and then heating the mixture so as to cause the powders to react together chemically.

4. A method for obtaining compounds as claimed in claim 1, comprising dissolving precursors selected from the nitrates, acetates and carbonates in water or in a mainly aqueous solvent, adding an α-hydroxycarboxylic acid complexing agent, and optionally a polyhydroxyalcohol cross-linking agent, to obtain a gel and then heating the gel obtained at a temperature of at least 1000° C.

5. A method for converting radiation into radiation with a higher energy level than that of the incident radiation, by using the compounds chosen from Y₂BaZnO₅:Er³⁺, La₂BaZnO₅:Er³⁺, Gd₂BaZnO₅:Er³⁺, Gd₂BaZnO₅:Yb³⁺/Er3+, and Gd₂BaZnO₅:Yb³⁺/Tm³⁺.
